(19) United States
(12) Patent Application Publication
(10) Pub. No.: US 2010/0232048 A1
(43) Pub. Date: Sep. 16, 2010

(54) DISK STORAGE DEVICE

(75) Inventor: Kimiyasu AIDA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/722,119

(22) Filed: Mar. 11, 2010

(30) Foreign Application Priority Data
Mar. 12, 2009 (JP) 2009-058876

(51) Int. Cl. G11B 5/09

(52) U.S. Cl. 360/48; G9B/5.033

(57) ABSTRACT

According to one embodiment, a disk storage device includes: a controller configured to write data pieces stored in a buffer memory to a disk medium by a physical sector size which is an integer multiple of a unit logical block, wherein the controller is configured to detect at least one of the write data pieces stored in the buffer memory, the at least one of the write data pieces being to be written to a portion of a physical sector of the disk medium, configured to store the at least one of the write data pieces to the non-volatile memory, configured to store the rest of the write data pieces to the disk medium, and configured to write, upon non-detection of a command for a predetermined time period, the at least one of the write data pieces to the disk medium by the physical sector size through read-modify-write processing.

### CROSS-REFERENCE TO RELATED APPLICATIONS

This application is based upon and claims the benefit of priority from Japanese Patent Application No. 2009-58876, filed Mar. 12, 2009, the entire contents of which are incorporated herein by reference.

### BACKGROUND

1. Field

One embodiment of the invention relates to a disk storage device that performs write processing on a disk storage medium with a physical sector size of an integer multiple of a logical block size.

2. Description of the Related Art

A physical sector size of a disk device may not correspond to a logical sector size that is a unit of writing data (unit logical block) of a host. For example, when the physical sector size is 4 Kbytes and the logical sector size is 512 bytes, one physical sector in a disk medium stores data of 8 logical sectors.

When the host transmits pieces of write data (write data pieces) each with the unit logical block to the disk device, the size of the logical sector needs to correspond to the size of the physical sector. When the size of the entire write data (or all of the write data pieces of the write data) coincides with the physical sector size, the write processing can be easily performed.

However, even when only one of the write data pieces is contained in a portion of the physical sector, it is required to read the entire physical sector. Accordingly, after modifying the portion (logical sector) by the one of the write data pieces, it is required to construct data of the physical sector size, and write the constructed data to the disk medium by the physical sector size.

The logical sector corresponding to the portion is called a fractional sector, and the above write processing is called read-modify-write processing. The read-modify-write processing is required for the writing of the write data pieces of the fractional sectors at the beginning portion and at the end portion of the write data transmitted from the host, and is required for the writing of the write data pieces of substitution blocks transmitted from the host. Accordingly, a rotational delay of the disk occurs and the throughput decreases.

Conventionally, a method for preventing the decrease in the throughput is proposed (for example, refer to Japanese Patent Application Publication (KOKAI) No. 2005-209119). In the method, all of the write data pieces from the host is stored in a non-volatile memory for a time until writing to the disk medium becomes possible, such as a disk seek time, a rotational delay, and the like. Then, the write data pieces stored in the non-volatile memory are read out therefrom, modified, and written to the disk medium, when the writing to the disk medium becomes possible.

The number of rewritable times is limited for many non-volatile memories. Regarding a flash memory that is a typical non-volatile memory, it is known that the number of rewritable times is 100,000 times for single level cell (SLC) and 10,000 times for multi level cell (MLC).

In a conventional method, all of the write data pieces contained in the entire write data are written to the non-volatile memory, thereby the number of rewritable times is reached in a short period of time. For example, although data of 128 Kbytes can be written to the non-volatile memory in 1.2 ms, there is a rotational delay of 6 ms in a 10,000 rpm magnetic disk, thereby most write data is written to the non-volatile memory.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a disk storage device according to an embodiment of the invention;

FIG. 2 is an exemplary block diagram of the disk storage device in FIG. 1 in the embodiment;

FIG. 3 is an exemplary management table of a non-volatile memory in FIG. 2 in the embodiment;

FIG. 4 is an exemplary diagram of a physical block of the non-volatile memory in FIG. 2 in the embodiment;

FIG. 5 is an exemplary diagram for explaining write processing in the embodiment;

FIG. 6 is an exemplary flowchart of a first part of read/write processing in the embodiment;

FIG. 7 is an exemplary flowchart of a second part of the read/write processing in the embodiment;

FIG. 8 is an exemplary flowchart of detection processing of a fractional sector in the embodiment;

FIG. 9 is an exemplary diagram for explaining the write processing to the non-volatile memory in the embodiment; and

FIG. 10 is an exemplary diagram for explaining read processing from the non-volatile memory in the embodiment.

### DETAILED DESCRIPTION

Various embodiments according to the invention will be described hereinafter with reference to the accompanying drawings, in the order of a disk storage device, read/write processing, and write processing to a non-volatile memory, and other embodiments. In general, according to one embodiment of the invention, a disk storage device comprises: a disk mechanism configured to read and write data with respect to a rotating disk medium; a non-volatile memory configured to store data; a buffer memory configured to store write data pieces transmitted from a host, each of the write data pieces having a unit logical block; and a controller configured to write the write data pieces stored in the buffer memory to the disk medium by a physical sector size which is an integer multiple of the unit logical block, wherein the controller is configured to detect at least one of the write data pieces stored in the buffer memory, the at least one of the write data pieces being to be written to a portion of a physical sector of the disk medium having the physical sector size by the unit logical block, configured to store the at least one of the write data pieces to the non-volatile memory, configured to store a rest of the write data pieces stored in the buffer memory other than the at least one of the write data pieces to the disk medium, the rest of the write data pieces having the physical sector size, configured to send, after the rest of the write data pieces are stored in the disk medium, a response to the host, and configured to write, upon non-detection of a command from the host for a predetermined time period, the at least one of the write data pieces stored in the non-volatile memory to the disk medium by the physical sector size through read-modify-write processing.

Hereinafter, embodiments of the invention will be described in an order of a disk storage device, read/write processing, write processing on a non-volatile memory, and other embodiments.

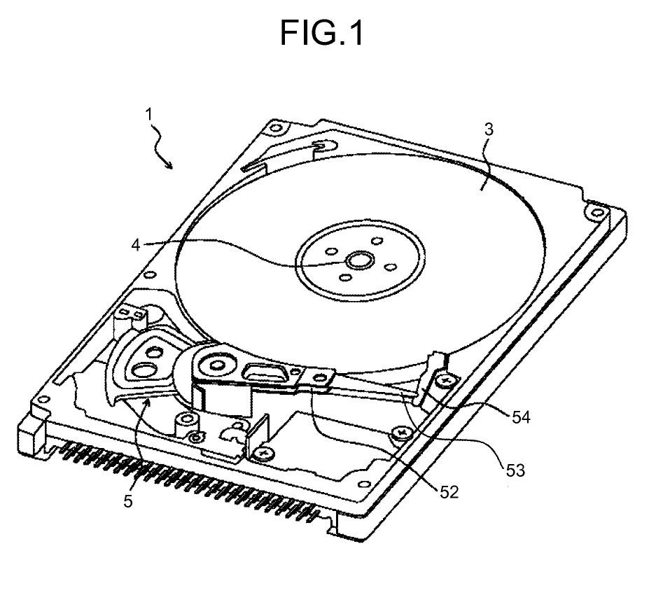

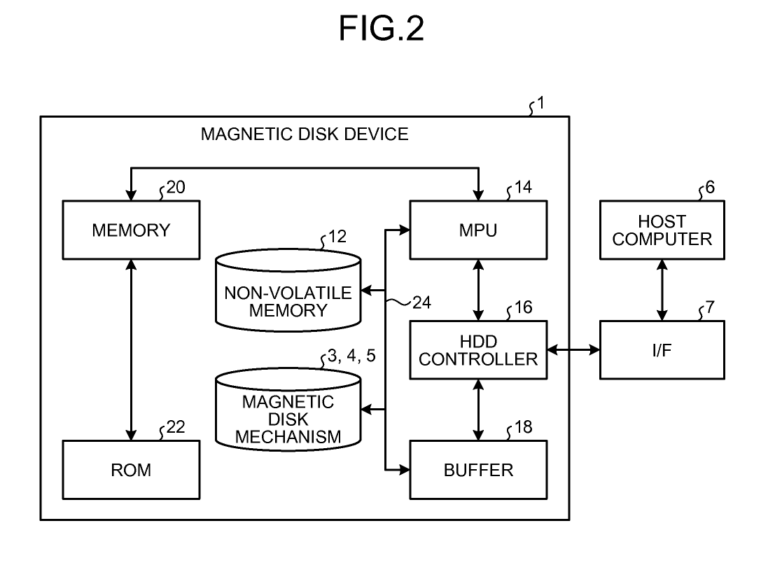

FIG. 1 is a perspective view of a disk storage device according to an embodiment of the invention, and FIG. 2 is a block diagram of the disk storage device in FIG. 1. As an example of the disk storage device, FIG. 1 illustrates a magnetic disk device (hard disk drive: HDD) which reads/writes data with respect to a magnetic disk.

As illustrated in FIG. 1, a magnetic disk device 1 comprises a magnetic disk 3, a spindle motor 4 for rotating the magnetic disk 3, a magnetic head 53 for reading/writing data from/to the magnetic disk 3, and an actuator (voice coil motor: VCM) 5 for moving the magnetic head 53 in a radial direction of the magnetic disk 3 (track traversing direction) in a disk enclosure. The above components constitute a disk mechanism.

A suspension 52 is provided to an arm of the actuator 5, and the magnetic head 53 is mounted on a top end of the suspension 52. The magnetic head 53 is constituted by providing a read element and a write element to a slider.

As illustrated in FIG. 2, the magnetic disk device 1 is connected to a host computer 6 via an interface I/F (connection line) 7. The I/F 7 may be in compliance with a standard such as serial advanced technology attachment (SATA).

The magnetic disk device 1 comprises a hard disk controller (HDC) 16, a micro processing unit (MPU) 14, a buffer memory 18, a volatile memory (random access memory: RAM) 20, a read only memory (ROM) 22, a non-volatile memory 12, and magnetic disk mechanisms (FIG. 1) 3, 4, and 5.

The MPU 14, the buffer memory 18, the non-volatile memory 12, and the magnetic disk mechanisms 3, 4, and 5 are connected to each other by a bus 24. The HDC 16 is connected to the MPU 14 and the buffer memory 18 by an internal line. The MPU 14 is connected to the RAM 20 and the ROM 22 by an internal line.

The HDC 16 performs interface control for the host, analyzes a command from the host, transmits the command to the MPU 14, and controls the buffer memory 18. The ROM 22 stores firmware that is loaded therefrom into the RAM 20 when the power is turned on.

The MPU 14 executes the firmware loaded into the RAM 20 to perform the read/write control with respect to the magnetic disk mechanisms 3, 4, and 5 and perform read/write control of a fractional sector with respect to the non-volatile memory 12.

The buffer memory 18 functions as a cache memory, stores a command and write data from the host, and stores read data from the magnetic disk 3. The non-volatile memory 12 is constituted by a flash memory, and temporarily stores data of the fractional sector of the write command received from the host.

The magnetic disk mechanisms 3, 4, and 5 comprise a motor drive controller (not illustrated in FIGS. 1 and 2) for drive-controlling the spindle motor 4 and the VCM 5, a read channel circuit (not illustrated in FIGS. 1 and 2) for generating a read gate, a write gate, a read clock, and a write clock, and a head IC (not illustrated in FIGS. 1 and 2) for flowing a recording current in the magnetic head 53 according to the write data while writing, and amplifying a read signal from the magnetic head 53 to output the read signal to the read channel circuit while reading.

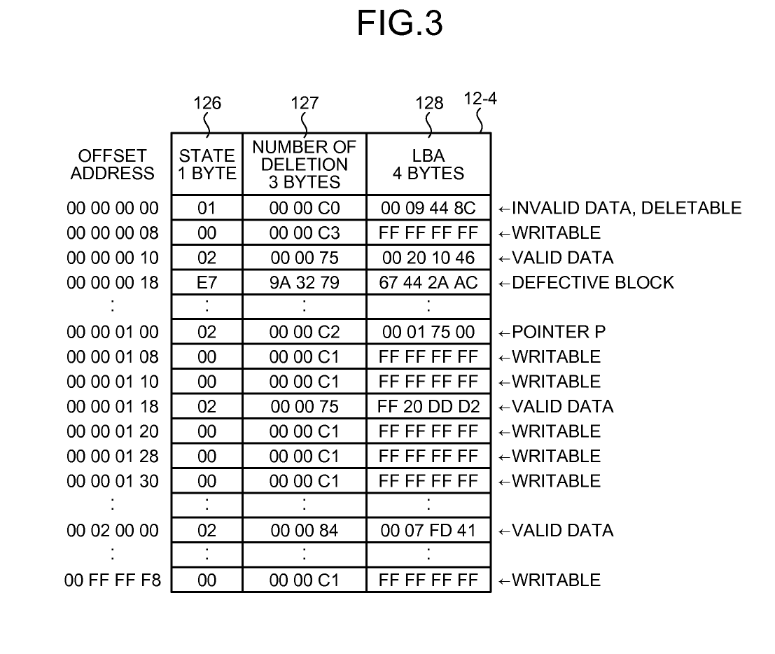

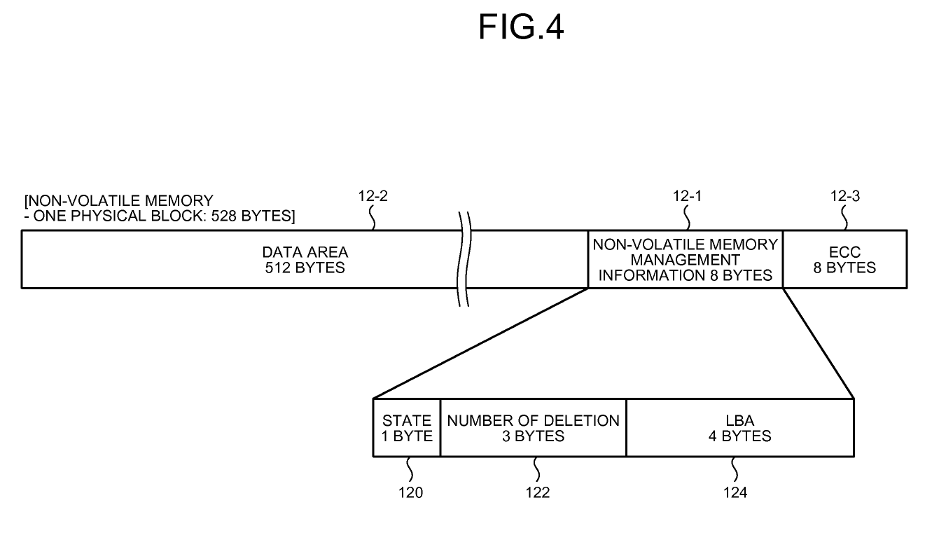

FIGS. 3 and 4 are diagrams illustrating management information of the non-volatile memory 12 and a physical block. As illustrated in FIG. 4, one physical block of the non-volatile memory 12 is constituted by a data area 12-2, memory management information 12-1, and an error check and correct (ECC) 12-3. The ECC 12-3 stores an ECC including data and management information.

For example, when one physical block of the non-volatile memory 12 is 528 bytes, 512 bytes are assigned to the data area 12-2, 8 bytes are assigned to the memory management information 12-1, and 8 bytes are assigned to the ECC 12-3.

The memory management information 12-1 comprises a state of a physical block 120, a number of deletion 122, and a logical block address (LBA) 124 of the corresponding physical block 120. When data is written to the non-volatile memory 12 or data is deleted from the non-volatile memory 12, the memory management information 12-1 is updated along with the memory management table described in FIG. 3. Accordingly, even when the power is shut down, the memory management information is prevented from being different from the data in the non-volatile memory 12.

A value of “00” as the information in the state 120 indicates that the corresponding physical block of the non-volatile memory 12 is writable (valid), a value of “01” as the information in the state 120 indicates that the corresponding physical block of the non-volatile memory 12 contains invalid data in the data area thereof so that the invalid data needs to be deleted from the data area before writing other data, a value of “02” as the information in the state 120 indicates that the corresponding physical block of the non-volatile memory 12 contains valid data in the data area thereof (invalid), and a value of “99” as the information in the state 120 indicates that the memory cannot be used because the maximum number of deletion is reached. Values other than the above indicate that the physical block is a defective block. Regarding the number of deletion (rewritable times) of a flash memory, 100,000 times are guaranteed for the SLC, and 10,000 times are guaranteed for the MLC.

The number of deletion 122 indicates a number of times the data in the physical block is deleted. A value of “FFFFFF” in the logical block address (LBA) 124 indicates that an address is not assigned, and values other than the above indicate that an address has been assigned. This assigned address is the LBA of the corresponding physical block.

A non-volatile memory management table 12-4 illustrated in FIG. 3 is constructed in the buffer memory 18, and updated along with the memory management information 12-1 of FIG. 4 when data is written or deleted with respect to the non-volatile memory 12. The non-volatile memory management table 12-4 is used for searching LBA when reading data from the corresponding physical block, searching LBA to delete old data in the corresponding physical block when writing data to the corresponding physical block, and equalizing the number of deletion associated with each physical block in the non-volatile memory 12.

The structure of the memory management table 12-4 is the same as that of the memory management information 12-1 in FIG. 4. The memory management table 12-4 comprises a state 126 of a physical block, the number of deletion 127, and a logical block address (LBA) 128 of the corresponding physical block, for each of the physical blocks of the non-volatile memory 12. Regarding offset address, a value of 66 times the offset address indicates a physical block address in the non-volatile memory 12. For example, a physical block address of a physical block of the non-volatile memory 12 to which data is previously written and pointed by a pointer P is “0x00004200”, and this physical address is 66 times the offset address “00000100”.

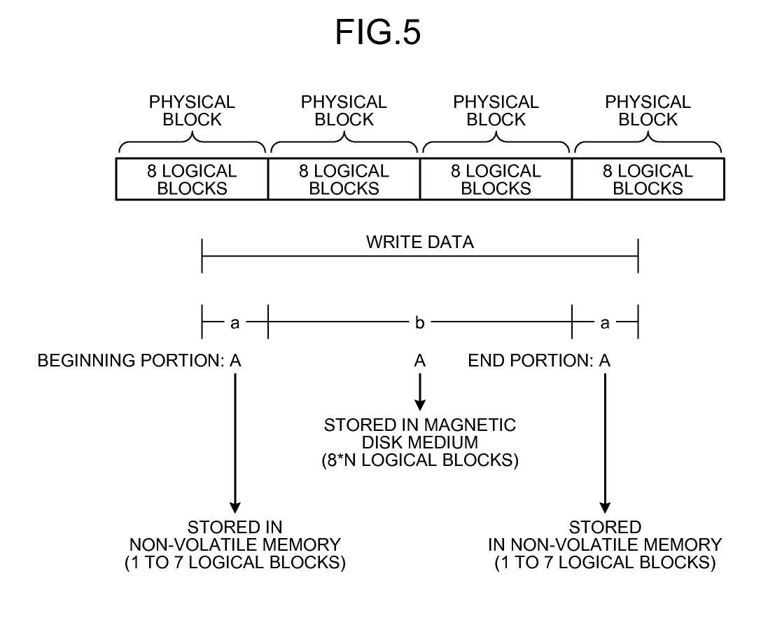

FIG. 5 is a diagram illustrating write processing of write data according to the embodiment. In FIG. 5, one physical block (sector size) of the magnetic disk 3 contains 8 logical blocks (logical sector size), for example. The write data transmitted from the host is received by the volatile memory (buffer) 18 and stored therein.

The write data received in the buffer memory 18 is stored separately in two storage areas described below. Write data pieces of fractional sectors “a” of the write data are stored in the non-volatile memory 12 instead of the magnetic disk 3 in order to avoid a disk rotational delay due to the read-modify-write processing. Write data pieces of middle sector b of the write data which causes no rotational delay is directly stored in the magnetic disk 3.

The write data received by the buffer memory 18 is stored in the magnetic disk 3 and the non-volatile memory 12 in an order such that one or more of write data pieces in the fractional sector “a” at a beginning portion of the write data is stored first, then one or more of the write data pieces in the middle sector “b”, and lastly one or more of the write data pieces in the fractional sector “a” at an end portion of the write data. The write data pieces of the fractional sector “a” at the beginning portion of the write data are written to the non-volatile memory 12 during a seek operation for writing the write data of the middle sector “b” to the disk medium 3.

After the write data pieces of the middle sector “b” has been written to the disk medium 3 (and if the write data pieces of the middle sector “b” contains a write data piece of substitution block, also after the write data piece of the substitution block is written to the non-volatile memory 12), the write data pieces of the fractional sector “a” at the end portion of the write data is written to the non-volatile memory 12.

As described above, when the write data pieces of the fractional sectors “a” at the beginning and end portions of the write data transmitted from the host are to be written to the magnetic disk medium 3, and also when the write data pieces of the middle sector “b” contains a write data piece of the substitution block, the write data pieces are not directly written to the magnetic disk medium 3, but temporarily stored in the non-volatile memory 12. Then, the write data pieces stored in the non-volatile memory 12 is written to the magnetic disk medium 3 when the device is in an idle state.

In this way, the disk rotational delay caused by the read-modify-write processing disappears, and the write speed of the write data can be increased. In addition, since only the write data pieces of the fractional sectors are written to the non-volatile memory 12, the use life can be extended for the non-volatile memory 12 having limited number of deletion, and the stable writing at high-speed can be maintained for a long time period.

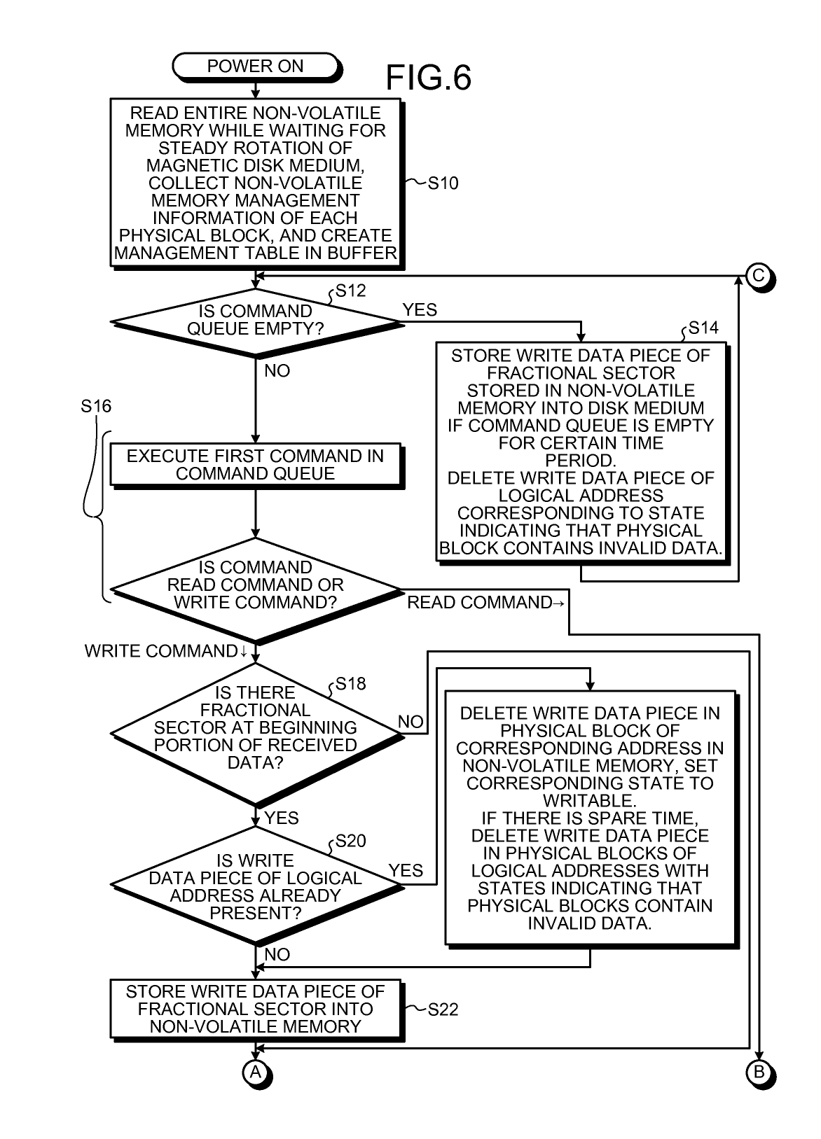

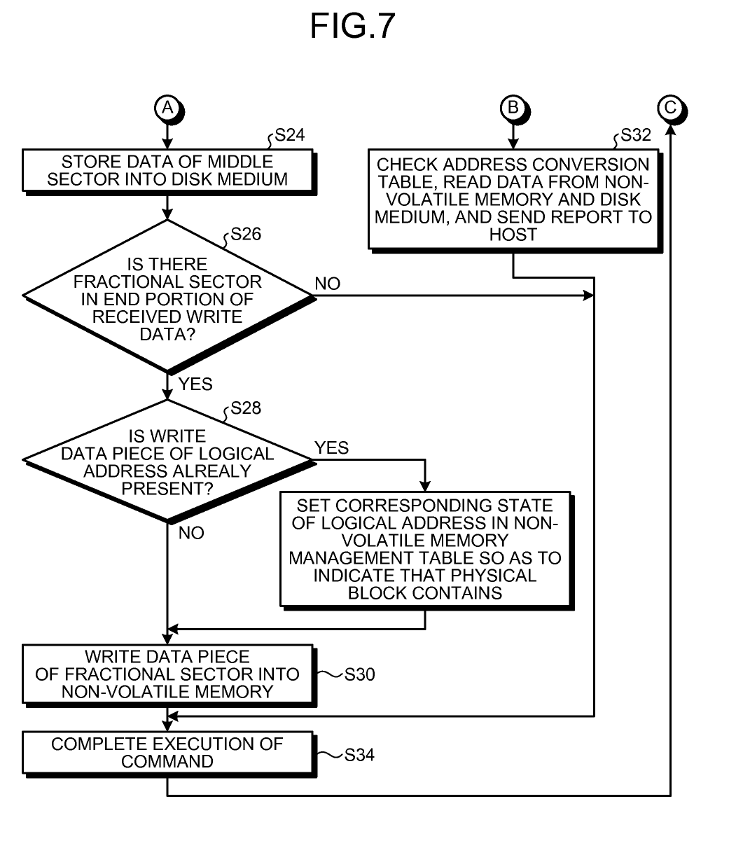

FIGS. 6 and 7 are flowcharts of the read/write processing of the embodiment.

In S10, the magnetic disk 3 is driven and rotated after the device is turned on. Further, until the magnetic disk 3 reaches a steady rotational speed, the MPU 14 reads data in all of the physical blocks of the non-volatile memory 12, collects the memory management information 12-1 for each physical block, and creates the non-volatile memory management table 12-4 described in FIG. 4 in the buffer memory 18.

Then, the MPU 14 checks whether the HDC 16 has a command in a command queue (S12).

When the MPU 14 determines that the HDC 16 does not have the command in the command queue (when the command queue is empty) (Yes at S12), the MPU 14 determines whether the HDC 16 does not have the command in the command queue for a certain time period, and when the HDC 16 does not have the command (when no command is received from the host) for the certain time period, the MPU 14 stores write data pieces of the fractional sector stored in the non-volatile memory 12 to the disk medium 3 (S14). Specifically, the MPU 14 reads out a physical block (sector) of the magnetic disk 3 including the fractional sector from the magnetic disk 3, rewrites the write data pieces of the fractional sector (logical sector) read out from the magnetic disk 3 by the write data stored in the non-volatile memory 12, creates a new physical block of the magnetic disk 3 including the rewritten write data pieces of the fractional sector, and write the new physical block to the magnetic disk 3 to replace the old physical block by the new physical block. This aforementioned process is so-called read-modify-write processing. Thereafter, the MPU 14 deletes the data in the non-volatile memory 12, increments the number of deletion of the corresponding logical address in the non-volatile memory management table 12-4, and sets “00” (writable) and “FFFFFFFF” (logical address not being assigned) in the logical address. In addition, by using this spare time, the MPU 14 deletes data under logical addresses in which the state information 126 in the non-volatile memory management table 12-4 is “01” (invalid data). Then, the MPU 14 returns to S12.

When the MPU 14 determines that the HDC 16 has the command in the command queue, the MPU 14 executes a first command in the command queue, and determines whether the command is a read command or a write command (S16). When the MPU 14 determines that the command is the read command, the MPU 14 proceeds to S32 in FIG. 7.

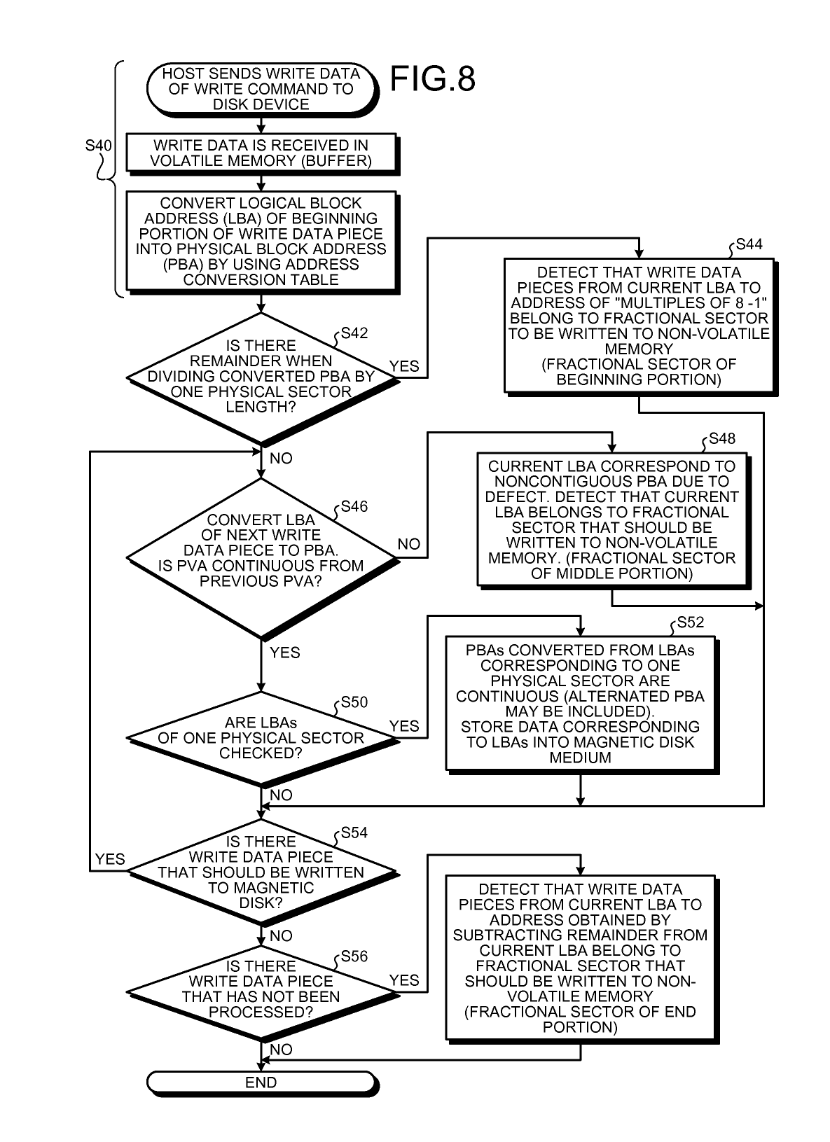

On the other hand, when the MPU 14 determines that the command is the write command, the MPU 14 determines whether there is a fractional sector at the beginning portion of the received write data (S18). This determination processing will be described in FIG. 8. When the MPU 14 determines that there is no fractional sector at the beginning portion of the write data, the MPU 14 proceeds to S24 in FIG. 7.

In S20, when the MPU 14 determines that there is a fractional sector at the beginning portion of the write data, the MPU 14 refers to the non-volatile memory management table 12-4 in the buffer memory 18 by using the LBAs of the write data pieces of the fractional sector, and determines whether the physical blocks of the LBAs of the non-volatile memory 12 to which the write data pieces in the fractional sector are to be written contains valid data. When the MPU 14 determines that the physical blocks of the LBAs of the non-volatile memory 12 contains the valid data, the MPU 14 deletes the valid data from the physical blocks of the non-volatile memory 12, and sets the state of the physical blocks of the LBAs in the non-volatile memory management table 12-4 to “00” (writable). In addition, if there is a spare time, the MPU 14 deletes data in physical blocks of LBAs corresponding to the states 126 in the non-volatile memory management table 12-4 of “01” (invalid data), and sets the states in the non-volatile memory management table 12-4 to “writable”. Then, the MPU 14 proceeds to S22.

The MPU 14 refers to the non-volatile memory management table 12-4, searches for an address with the state of “writable” in ascending order from an address subsequent to the physical address to which write data piece is previously written, and stores the write data piece of the fractional sector at the beginning portion of the write data in the buffer memory 18 to the physical block of the searched address in the non-volatile memory 12 (S22). As described below, to equalize the number of rewriting of the non-volatile memory, the non-volatile memory is used as a ring buffer. After the write data piece is written, the MPU 14 sets the state of the corresponding address in the non-volatile memory management table 12-4 to indicate that the physical block contains valid data.

Next, the MPU 14 writes the write data piece of the middle sector of the write data to the magnetic disk medium 3 (S24).

Then, the MPU 14 determines whether there is a fractional sector at the end portion of the received write data (S26). This determination processing will be described in FIG. 8. When the MPU 14 determines that there is no fractional sector at the end portion of the write data, the MPU 14 proceeds to S34.

When the MPU 14 determines that there is a fractional sector at the end portion of the write data, the MPU 14 refers to the non-volatile memory management table 12-4 in the buffer memory 18 by using the LBAs of the write data pieces of the fractional sector, and determines whether the physical block of the LBAs of the non-volatile memory 12 to which the write data pieces of the fractional sector are to be written contains valid data (S28). When the MPU 14 determines that the physical blocks of the LBAs of the non-volatile memory 12 contain the valid data, the MPU 14 sets the state of the corresponding logical address in the non-volatile memory management table 12-4 to “01” (is the physical block contains invalid data). Here, the data is not deleted, and the data is to be deleted in the idle state or during a seek operation of the disk. Then, the MPU 14 proceeds to S30.

The MPU 14 refers to the non-volatile memory management table 12-4, searches for an address with a state of “writable” in ascending order started from an address subsequent to the physical address of the physical block to which the write data piece is previously written, and stores the write data piece of the fractional sector at the end portion of the write data stored in the buffer memory 18 into the physical block of the searched address in the non-volatile memory 12 (S30). As described below, to equalize the number of rewrite times of the non-volatile memory, the non-volatile memory is used as a ring buffer. After the data is written, the MPU 14 sets the states of the corresponding addresses in the non-volatile memory management table 12-4 to indicate that the physical block contains valid data.

On the other hand, when the MPU 14 determines that the command is the read command in S16, the MPU 14 refers to an address management table in the RAM 20, and reads data from the non-volatile memory 12 or the magnetic disk 3 to the buffer memory 18 (S32). Then, the HDC 16 transfers the read date to the host. Then, the MPU 14 proceeds to S34. The address management table is a table for converting the LBA to the physical block address (PBA) such as cylinder, head, and sector. The address management table is stored in a system area of the magnetic disk 3, and read from the magnetic disk 3 to the RAM 20 when the power is turned on.

In S34, the MPU 14 completes the execution of the command, sends a completion report to the host, and returns to S6 in FIG. 6.

Next, processing for detecting the fractional sector when the write data is received will be described with reference to FIG. 8.

In S40, the write data is transmitted from the host, and stored in the buffer memory 18. Further, the MPU 14 converts the LBA of a write data piece at a head of the write data into a PBA by using the address conversion table described above.

The MPU 14 divides the converted PBA by one physical sector length (size), and determines whether there is a remainder or not (S42). The LBA and the PBA have the same sector size. As illustrated in FIG. 5, since one physical sector length equals to 8 logical block lengths, the MPU 14 divides the PBA by 8, and determines whether there is a remainder or not.

When the MPU 14 determines that there is a remainder, the MPU 14 detects that the write data piece having the current LBA and up to the write data piece having the LBA of “multiples of 8−1” belongs to the fractional sector (fractional sector at the beginning portion of the write data) that is to be written to the non-volatile memory 12 (S44). Then, the MPU 14 proceeds to S54.

When the MPU 14 determines that there is no a remainder, the MPU 14 converts write data piece of next LBA to the PBA, and determines whether the converted PBA is continuous from the PBA of the previous write data piece (in other words, converted PBA=previous PBA+1) or not (S46).

When the MPU 14 determines that the converted PBA is not continuous, the MPU 14 detects that the write data piece of this LBA belongs to a fractional sector that is to be written to the non-volatile memory 12 (fractional sector at the middle portion of the write data) because the LBA has a PBA which is not continuous due to a defective sector substitution (substitute sector) (S48). Then, the MPU 14 proceeds to S54.

When the MPU 14 determines that the converted PBA is continuous, the MPU 14 determines whether the LBA of one physical sector length has been checked (S50). When the MPU 14 determines that the LBA of one physical sector length has not been checked, the MPU 14 proceeds to S54.

When the MPU 14 determines that the LBA of one physical sector length has been checked, the MPU 14 determines that the write data piece corresponding to the LBA (write data piece at the middle portion of the write data) should be stored in the magnetic disk because the PBA which is converted from the LBA of one physical sector length is continuous (S52). Then, the MPU 14 proceeds to S54.

The MPU 14 determines whether there is still write data pieces which should be written to the magnetic disk 3 (S54). When there is still write data pieces which should be written to the magnetic disk 3, the MPU 14 returns to S46.

When the MPU 14 completes the check for the write data piece which should be written to the magnetic disk (check for the sector at the middle portion), the MPU 14 determines whether there is a write data pieces which has not been processed (S56). When there are no write data pieces which have not been processed, the MPU 14 ends the process. On the other hand, when there is a write data piece which has not been processed, the MPU 14 detects that the write data piece of the current LBA to the write data piece of the last remained LBA are the write data pieces of the fractional sector (fractional sector at the end portion of the write data) that should be written to the non-volatile memory 12 (S58), and ends the process.

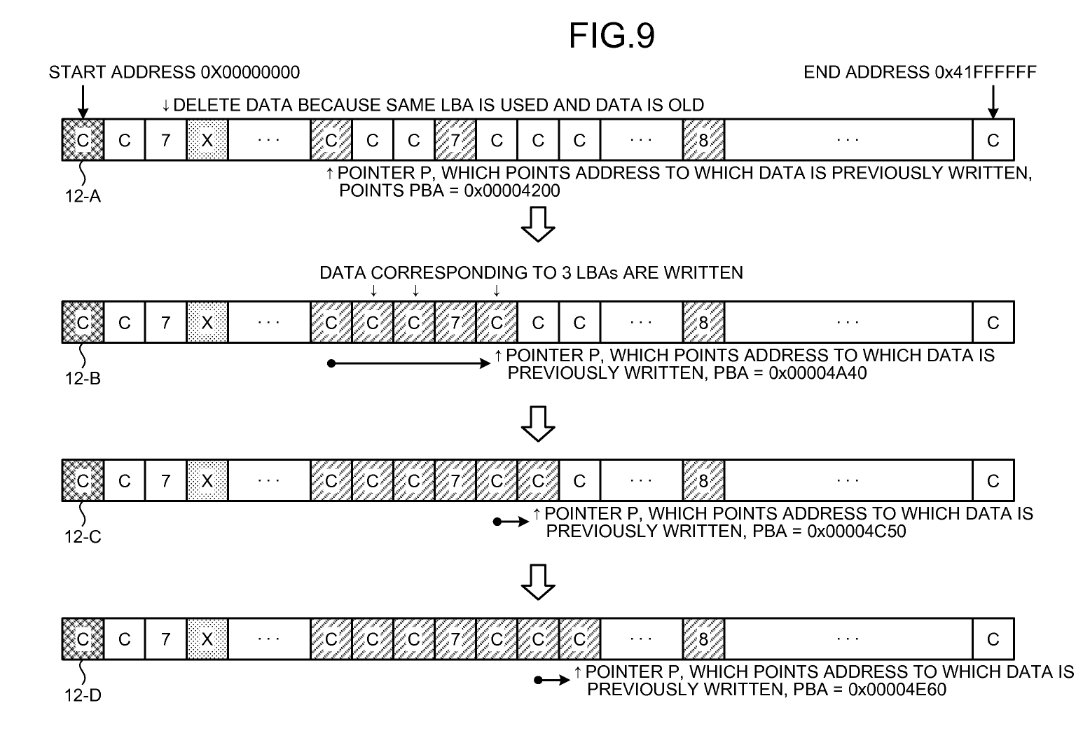

Next, a method for equalizing the number of deletion of the non-volatile memory will be described. FIG. 9 is illustrates the write processing with respect to the non-volatile memory, and illustrates a physical image of the non-volatile memory in a state illustrated in the non-volatile memory management table 12-4 of FIG. 3.

As illustrated by 12-A in FIG. 9, the exemplary non-volatile memory 12 has a start address of “0x00000000” and an end address of “0x41FFFFFF”. For example, the non-volatile memory 12 has a capacity of 1056 Mbytes, including a data area of 1 Gbytes, management information of 16 Mbytes, and an ECC of 16 Mbytes.

The square in FIG. 9 indicates one physical block. A white block indicates a writable block, a shaded block comprises valid data, a mesh block comprises invalid data which needs to be deleted, and a dotted block indicates a defective block. The number in the block indicates the number of deletion. The PBA to which data is previously written and pointed by the pointer P is assumed to be “0x00004200”.

It is described in the following the write processing performed based on a write command of the host, with LBA of 0x00201045 and the number of LBAs of 0x14. First, it is described the case when the write data pieces of the fractional sector at the beginning portion of the write data is written to the non-volatile memory.

For example, the first LBA of “0x00201045” of the write data is converted into PBA of “0x00201045”. The PBA cannot be divided by one physical sector size (8 LBAs), so that the PBA is that of the fractional sector. Accordingly, the fractional sector is detected in the beginning portion of the write data. The range of the fractional sector of the beginning portion continues to an address represented by “multiples of one physical sector−1”. Specifically, three LBAs from “0x00201045” to “0x00201047” represent the fractional sector at the beginning portion of the write data.

The case in 12-A of FIG. 9 illustrates the case when a repetitive LBA (old data) is searched for writing the fractional sector of the beginning portion of the write data to the non-volatile memory 12, and the redundancy in the LBA is found at “0x00201046”. Accordingly, the LBA of “0x00201046” is deleted.

Next, it is checked that there are no more repetitive LBAs, and pieces of the write data (write data pieces) corresponding to the three LBAs are written to the non-volatile memory 12. The PBAs of the physical blocks of the non-volatile memory 12 to which the write data pieces are written corresponds to writable blocks having addresses lower than the address of a physical block of the non-volatile memory 12 to which a write data piece was previously written. In the example of 12-A in FIG. 9, there is valid data in a physical block of the PBA of “0x00004830”, so that the block with this PBA is skipped, and the write data pieces with the three LBAs are written as illustrated in 12-B in FIG. 9. To equalize the number of rewrite times of the non-volatile memory 12, the non-volatile memory 12 is used as a ring buffer to write the write data pieces.

Next, it is described the case when the write data of the fractional sector at the middle portion of the write data is written to the non-volatile memory 12. The LBAs from “0x00201048” to “0x00201057” are converted into PBAs having the same addresses as those of the LBAs except for the LBA of “0x0020104C”. In other words, the PBA of the LBA of “0x0020104C” has been alternated due to failure. Accordingly, the write data belonging to the alternated PBA is used as that of a fractional sector.

In this case, the write data is written to the PBAs from “0x00201048” to “0x00201057” which correspond to one physical sector length of the magnetic disk medium, and the data of the LBA of “0x0020104C” is written to the non-volatile memory 12 as illustrated in 12-C in FIG. 9.

Next, it is described the case when the write data of the fractional sector at the end portion of the write data is written to the non-volatile memory. It is checked that the LBA of “0x00201058” is converted into PBA having the same address as the LBA. This LBA is the last LBA and there is no data after the LBA. Since the LBA comprises 7 logical blocks or less, the LBA is handled as a fractional sector, and written to the non-volatile memory 12 as illustrated in 12-D in FIG. 9.

Thereafter, a write completion notice of data is sent to the host, and the execution of the write command is completed.

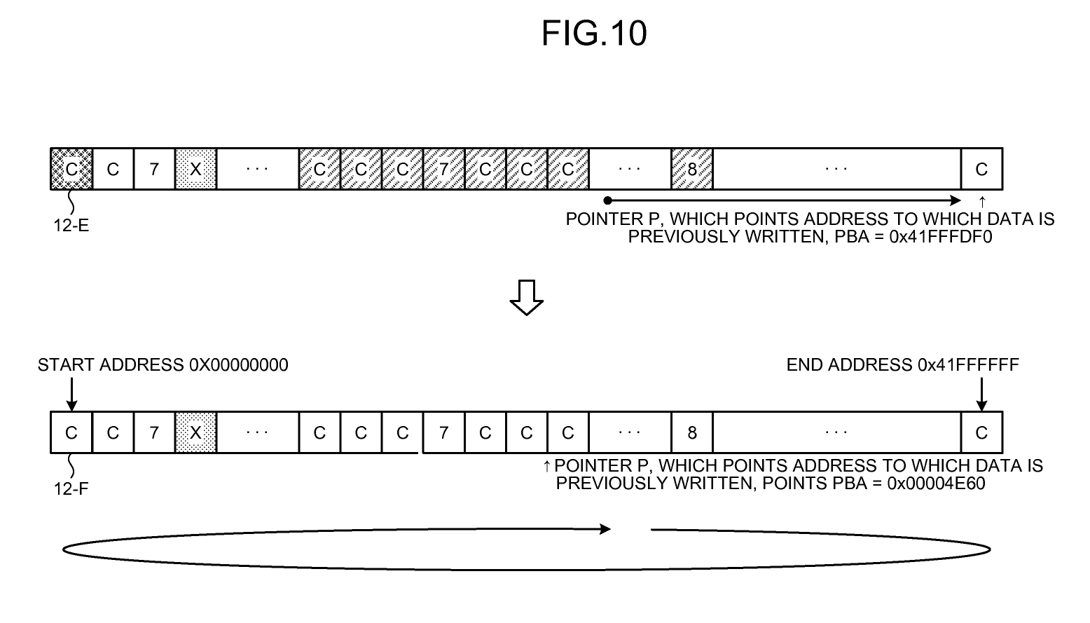

FIG. 10 is an illustration of data transfer processing from the non-volatile memory to the magnetic disk.

When the command queue is empty for a specific time period, the write data of the fractional sectors stored in the non-volatile memory 12 is written to the magnetic disk 3. Therefore, as illustrated in 12-E in FIG. 10, valid data (shaded blocks) is read from the address next to the pointer P pointing the address to which the write data is previously written to the non-volatile memory 12, and corresponding physical sectors are read from the magnetic disk 3, and then the read-modify-write is performed.

The blocks written to the magnetic disk 3 are changed to writable (white) blocks as illustrated in 12-F in FIG. 10. After the above reading, the pointer P pointing the address to which data is previously written is moved to a position of a block previously contained the write data written to the magnetic disk. Therefore, the number of rewrite times is equalized, and hence the life of the non-volatile memory 12 can be extended.

The disk storage device according to the embodiment detects, when write data is to be written to a disk medium with a physical sector size that is an integer multiple of a size of a logical block, a portion of the write data that is to be written to a portion within the physical sector size by a unit logical block. Then, the disk storage device stores the portion of the write data in a non-volatile memory, and stores the rest of the write data having the physical sector size to the disk medium. Thereafter, the disk storage device reports a notice to the host. Consequently, the disk storage device according to the embodiment can improve the throughput thereof, and can extend the use life thereof.

Although the disk storage device is described using a magnetic disk device, the embodiment can be applied to other disk storage devices such as an optical disk and an optical magnetic disk. Although the non-volatile memory is described using a flash memory, the embodiment can be applied to other non-volatile memories, the number of rewritable times of which is limited. Further, although the number of logical blocks in one physical block is eight in the description, actually the number of logical blocks may be more than one.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk storage device comprising:
a disk access module configured to read and write data with respect to a rotating disk medium;
a non-volatile memory configured to store data;
a buffer memory configured to store write data from a host, each of the write data in a size of a logical block; and
a controller configured to write the write data in the buffer memory to the disk medium by a physical sector size which is an integer multiple of the size of the logical block, wherein
the controller is configured to detect a first portion of the write data in the buffer memory, the first portion of the write data to be written to a portion of a physical sector of the disk medium comprising the physical sector size, configured to store the first portion of the write data to the non-volatile memory, configured to store a second portion of the write data in the buffer memory to the disk medium, the second portion of the write data comprising the physical sector size, configured to send a response to the host after the second portion of the write data is stored in the disk medium, and configured to write the first portion of the write data in the non-volatile memory to the disk medium by the physical sector size through read-modify-write processing, upon failure to detect a command from the host for a predetermined time period.

2. The disk storage device of claim 1, further comprising:
a management table configured to indicate a state of each write block in the non-volatile memory, wherein
the controller is configured to set a state of a first portion of the write blocks configured to store the first portion of the write data in the management table after the first portion of the write data is written to the non-volatile memory, the state is indicative whether the first portion of the write blocks comprises valid data.

3. The disk storage device of claim 1, wherein the controller is configured to detect the first portion of the write data by dividing a logical block address of the first portion of the write data by the integer multiple.

4. The disk storage device of claim 1, wherein the controller is configured to change a target write block of the non-volatile memory configured to store the first portion of the write data in a circulative manner as a ring buffer.

5. The disk storage device of claim 2, wherein the controller is configured to read the first portion of the write data in the first portion of the write blocks comprising a state in the management table indicating that the first portion of the write blocks comprises valid data, and to write the first portion of the write data to the disk medium by the physical sector size through the read-modify-write processing.

6. The disk storage device of claim 1, wherein the controller is configured to receive a physical block address corresponding to a logical block address of the first portion of the write data, to read data of a physical sector of the disk medium comprising the physical block address, to rewrite the read data of the physical sector by the first portion of the write data, and to write the rewritten data to the physical sector in the disk medium.

7. The disk storage device of claim 2, wherein the controller is configured to search a write block with a state set as writable in the management table, to write the first portion of the write data to the searched write block, and to set the state of the searched write block in the management table, the state is indicative whether the searched write block comprises valid data.

8. The disk storage device of claim 5, wherein the controller is configured to set the state of the first portion of the write blocks in the management table as writable, after writing the first portion of the write data in the non-volatile memory to the disk medium.

9. The disk storage device of claim 7, further comprising:
a pointer configured to indicate a write block of the non-volatile memory where the first portion of the write data is previously written, wherein
the controller is configured to search a write block with a state indicative of writable in the management table by moving the pointer.

10. The disk storage device of claim 1, wherein the controller is configured to convert a logical block address of the first portion of the write data into a physical block address, to detect the first portion of the write data by dividing the physical block address by the integer multiple, to detect that physical block addresses of the second portion of the write data is continuous in the physical sector size, and to extract the second portion of the write data corresponding to the physical sector size.

11. The disk storage device of claim 10, wherein the controller is configured to detect a physical block address discrete in the physical sector size from the physical addresses of the second portion of the write data, and to write a write data with the discrete physical block address to the non-volatile memory.

12. The disk storage device of claim 1, wherein a number of writing times of the non-volatile memory is limited.
